(19) United States
(12) Patent Application Publication
(10) Pub. No.: US 2016/0052774 A1
(43) Pub. Date: Feb. 25, 2016

(54) COPPER ALLOY FOR PRODUCING HORSE BITS OR HORSE BIT PARTS

(71) Applicant: HERM. SPRENGER GMBH & CO. KG, Iserlohn (DE)

(72) Inventors: Valentin Völlmecke, Iserlohn (DE); Heinz Baumann, Iserlohn (DE)

(21) Appl. No.: 14/782,571

(22) PCT Filed: Dec. 17, 2013
(86) PCT No.: PCT/EP2013/076886

§ 371 Date: Oct. 5, 2015

(30) Foreign Application Priority Data
Apr. 5, 2013 (DE) 10 2013 206 047.5

(51) Int. Cl. B68B 1/06; C22C 9/04; C22C 9/05

(52) U.S. Cl. CPC B68B 1/06; C22C 9/05; C22C 9/04

(57) ABSTRACT

A copper alloy to produce for horse bits or parts thereof is composed of 1 wt % to 30 wt % manganese, 1 wt % to 30 wt % zinc, and the remainder copper and other additives, the other additives in total being less than 6 wt %, in particular less than 3 wt %.

The invention relates to the use of a copper alloy for producing horse bits or parts thereof.

Copper alloys for the production of horse bits and in particular of bit bars or other bit parts of horse bits are used in a variety of manners. An alloy with 81 to 88% by wt., less than 4% by wt. silicon, the remainder being zinc including impurities, is known from EP 0 638 655 B1. From WO 2009/034387, a copper alloy is known with 65 to 99.95% by wt. copper; 25 to 36% by wt. zinc, 0.2 to 2.7% by wt. cobalt and other constituents, whose percentage by weight is in each case maximally 2% by wt., may be added. The other possible constituents are tin, at least one element from group 15 of the periodic table, zirconium, Al2O3, chromium and beryllium.

Nickel silver alloys have already been used for a longer period of time for producing horse bits; they typically contain 50-60% by wt. copper, about 10 to 20% by wt. nickel, the remainder being zinc and inevitable impurities.

A successful copper alloy for producing horse bits is comprised of about 85% by wt. copper, 3-4% by wt. silicon, the remainder being zinc and inevitable impurities. Horses take to this alloy very well. It is proved to induce horses to chew. The topline of the horses relaxes and the capacity to perform is significantly increased compared with other copper alloys. This successful copper alloy is used widely and successfully. On the one hand, its advantage lies in the sufficient hardness of the alloy, and, on the other hand, in the high copper content.

Now, however, there have repeatedly been discussions with respect to alleged “copper allergies” of horses. Indeed, the copper content of the successful alloy described above is relatively high; a high level of corrosion occurs in the horse's mouth. However, scientific investigations, which were also conducted at a university of veterinary medicine, did not reveal any disadvantageous effects of copper.

However, it appears to be indicated to test how low a copper content may be while still achieving the same effect in the horse's mouth as in the case of the successful alloy. As a result, it was contemplated and investigations were conducted on whether results could be obtained, with a lower content of copper and/or a lower solubility of copper in the alloy, as they are achieved with the above-mentioned alloy. In particular, these investigations had the aim of finding a lower threshold at which the horses still accept an alloy as well as the successful alloy, wherein, however, the new alloy exhibits a lower copper content and/or a lower level of solubility of the copper. It was found in the process that lower copper contents also lead to the results that were obtained with the successful alloy that had a high copper content.

In this case, one goal was that the new alloy be accepted by horses at least as well as the successful alloy consisting of copper, silicon and zinc. The chewing activity was supposed to be stimulated in at least the same measure as in the case of the successful alloy, and the willingness of the horse to perform was to be stimulated similarly well. The new alloy was supposed to have the same strength values as before, in particular strength values as they are generally required for bits. Preferably, the new alloy was supposed to have a lower level of solubility of copper and other alloy metals in the horse's saliva. On the whole, the new alloy was supposed to exhibit a lower level of corrosion of the surface. It was to exhibit a significantly improved appearance even when stored in the air and after a longer period of use.

The term horse bit is understood to mean, in particular, snaffle, curb, Pelham and full-cheek bits. A horse bit of the type discussed herein is a bit piece or mouth piece. A horse bit is considered a part of the bridle of a horse.

Reference is made to EP 1 140 693 B1 by the applicant for an example of a horse bit. At least those parts of such a horse bit that are located in the horse's mouth are supposed to be manufactured from the copper alloy.

The copper alloy is used for those parts of the horse bit that come into contact with the horse's saliva. Thus, the horse bit known from the above-mentioned patent exhibits outer rings. They need not be produced from the alloy; they are located outside the horse's mouth and do not come into contact with the saliva. In contrast, the parts of the aforementioned horse bit located between the rings come into contact with horse's saliva and are to be produced with the alloy.

Based on this, it is an object of the invention to further develop the copper alloy for horse bits known from the above-mentioned EP 0 638 655 B1 in such a way that a content by weight of copper and/or the solubility of copper in the alloy is reduced, but that the positive properties of the known copper alloy are maintained to the greatest extent possible.

The object is achieved by the copper alloy having the features of the use claim 1.

The production of saliva in horses is stimulated particularly well if such a CuMnZn alloy is used for horse bits of parts thereof. The desired cooperation between the horse and the rider is promoted. It was found in tests that the copper release into the horse's saliva is significantly reduced, typically by 60%. An impairment of performance or a preference of alloys according to the prior art could not be found.

Manganese is an important trace element. It is a constituent and activator of various important enzymes and is thus of importance, among other things, in the build-up of the connective tissue. By using manganese in the alloy, the horse is supplied with manganese. The horse takes up manganese via the saliva. In addition to its actual function as a part of the bridle, a bit produced with the alloy also has the function of supplying the horse with the trace element manganese. A use of manganese for horse bits is nowhere to be found in the prior art.

The corrosion rate of this CuMnZn alloy is approximately only 65% of the corrosion rate of the successful alloy. This makes clear that less Cu is dissolved, and that thus, the horses also receive less Cu via the saliva.

The percentage by weight of manganese is preferably more than 2% by wt., in particular more than 5% by wt., and preferably more than 9% by wt. The percentage by weight of manganese is preferably between 5 and 25% by wt., in particular between 8 and 20% by wt., and is preferably 12±2% by wt.

The percentage by weight of zinc is preferably more than 2% by wt., in particular more than 5% by wt., and preferably more than 9% by wt. The percentage by weight of zinc is preferably between 5 and 25% by wt., in particular between 8 and 20% by wt., and is preferably 13±2% by wt.

Preferably, the nickel content is less than 0.1% by wt.; preferably, it is less than 0.01% by wt.

Preferably, the percentage by weight of copper is more than 50%, in particular more than 60%. Preferably, the percentage by weight of copper is less than 75%, in particular less than 74%. Preferably, the percentage by weight of copper is between 65 and 75%, in particular between 72 and 74%.

The alloy may contain a maximum of 1.5% by wt. of aluminum and/or a maximum of 1.5% by wt. of silicon.

Preferably, the content of at least one of the metals Fe, Al, Mg, Ti, Pb, Sn, in particular of several of those in any selection, is less than 0.1% by wt.

The alloy according to the invention has a beautiful, substantially silvery luster. Its surface is easy to process and becomes smooth if processed accordingly. It can be polished. Also, the luster is more long-lasting than in prior alloys. Due to the reduced corrosion, the luster is more stable than in alloys according to the prior art.

CuMnZn alloys are known to have a germicidal effect. For example, the use of such alloys for door handles is known, e.g. for door handles in hospitals. A germicidal effect may have positive and negative consequences for a bit. In the case of the present alloy and its use for horse bits, the positive consequences are predominant. Even if the horse bit is not cleaned after use and after having been removed from the horse, only few germs accumulate; this is beneficial to the health of the horse when the bit is reinserted later on.

CuMnZn alloys for frames of glasses are known from EP 545 231 B 1. Reference is made to the information therein, in its entirety, regarding the individual alloys and their respective values. The contents of the disclosure of this patent application shall belong to the disclosure of the present application.

Tests with CuCaAg alloys for horse bits have also been carried out. However, these alloys do not exhibit the good properties that the alloy according to claim 1 has. The currently high silver price is also disadvantageous.

The alloy is as free from nickel as possible; this is beneficial from the viewpoint of a veterinarian. Nickel is known for its allergic effects.

The alloy has the strengths and the hardness required for bits of the type discussed herein. The hardness according to Brinell is preferably in the range of from 55 to 75 HB.

CuMnZn alloys for decorative articles are known from FR967018 (A). The contents of the disclosure thereof shall also belong to the disclosure of the present application.

The percentage by weight of manganese is preferably 12±1%. The percentage by weight of zinc is preferably 13±1%.

1. An apparatus comprising:
a horse bit or part thereof including a copper alloy comprising
1% by wt. to 30% by wt. of manganese,
1% by wt. to 30% by wt. of zinc,
the remainder being copper and impurities, wherein the impurities comprise less than 6% by wt. in total.

2. An apparatus according to claim 1, wherein the impurities comprise less than 2% by wt. in total.

3. An apparatus according to claim 1, wherein the percentage by weight of manganese is between 5 and 25% by wt.

4. An apparatus according to claim 1, wherein the percentage by weight of zinc is between 5 and 25% by wt.

5. An apparatus according to claim 1, wherein the percentage by weight of copper is between 65 and 75% by wt.

6. An apparatus according to claim 1, wherein the copper alloy contains one or more of a maximum of 1.5% by wt. of aluminum and a maximum of 1.5% by wt. of silicon.

7. An apparatus according to claim 1, wherein the content of nickel is less than 0.1% by wt.

8. An apparatus according to claim 1, wherein the content of at least one of metals Fe, Al, Mg, Ti, Pb, and Sn is less than 0.1% by wt.

9. An apparatus according to claim 1, wherein the impurities comprise less than 3% by wt. in total.

10. An apparatus according to claim 1, wherein the percentage by weight of manganese is between 8 and 20% by wt.

11. An apparatus according to claim 1, wherein the percentage by weight of manganese is 12±2% by wt.

12. An apparatus according to claim 1, wherein the percentage by weight of zinc is between 8 and 20% by wt.

13. An apparatus according to claim 1, wherein the percentage by weight of zinc is 13±2% by wt.

14. An apparatus according to claim 1, wherein the percentage by weight of copper is between 72 and 74% by wt.

15. An apparatus according to claim 1, wherein the content of nickel is less than 0.01% by wt.

16. An apparatus according to claim 1, wherein the total content of two or more of metals Fe, Al, Mg, Ti, Pb, and Sn is less than 0.1% by wt.
